(19) United States
(12) Patent Application Publication
(10) Pub. No.: US 2014/0182691 A1
(43) Pub. Date: Jul. 3, 2014

(54) HOT AND COLD WATER MIXER

(71) Applicant: Raymond Wallace James, Glenbrook (AU)

(72) Inventor: Raymond Wallace James, Glenbrook (AU)

(73) Assignee: BUILDING CODE CERTIFICATIONS PTY LTD, Glenbrook, NSW (AU)

(21) Appl. No.: 14/117,042

(22) PCT Filed: May 11, 2012
(86) PCT No.: PCT/AU2012/000506

§ 371 Date: Nov. 12, 2013

(30) Foreign Application Priority Data
May 13, 2011 (AU) 2011901808

(51) Int. Cl. G05D 23/19

(52) U.S. Cl. CPC G05D 23/19
USPC 137/3; 236/12.14

(57) ABSTRACT

An electro-mechanical system for control of a standard, normally manually operable, cold and hot water mixing device; said system including a first actuator for control of a cold-hot water balance entering said mixing device and a second actuator for control of flow of mixed cold and hot water through said mixing device.

### TECHNICAL FIELD

The present invention relates to mixing devices for the controlled combining of cold and hot water to an outlet and, more particularly, to electro-mechanical control, systems for such mixing devices.

### BACKGROUND

The mixing of water through plumbing fixtures has traditionally been performed by the manual manipulation of two taps. In more recent times, water has been mixed by a single device by the manual manipulation of a single handle.

In both the methods listed above, there is an inherent problem of waiting for hot water at a suitable temperature to reach the mixed water outlet point.

In particular a number of problems arise when mixing water for a shower via dual taps or a single handle mixing device. These include:—
(a) If one turns the shower on before disrobing there is the potential of clothing becoming wet as ones hand or arm is inserted under the shower to manipulate the taps.
(b) Similarly, when manipulating the taps there is the potential for discomfort as a result of unpleasant water temperatures until a suitable flow and temperature are established.
(c) Until a suitable flow and temperature are established, there is a considerable loss of water, particularly when the shower is turned on before one disrobes.
(d) There is also energy waste as there is a delay between establishing desired flow and temperature and actually using the shower.
(e) There is the potential for scalding and burns, particularly with the elderly and small children.
(f) There can be pressure fluctuations during showering with resultant flow and temperature variations which cause discomfort or annoyance.
(g) The need to change settings as the water temperature and/or pressure changes is a nuisance and wastes water.

Problems also occur with other plumbing fixtures which provide mixed water. Heed basins and similar fixtures used for washing hands have an inherent problem of coating the tap or mixer handle with the substance one is seeking to remove from ones hands. They contribute to the spreading of contaminants including bacteria and viruses. There is also splashing and dripping of unwanted material over elements of the fixture as one operates the taps or mixer. These fixtures also result in water and energy wastage as one waits for water at the desired temperature. Energy is also wasted (particularly when using a single hand mixing device) when a mixture of hot and cold water is selected when only cold water is required. For some people there is difficulty/impossibility in being able to turn handles.

Automated systems for the control of cold and hot water mixing are known. Thus for example US patent application US2010/0126612, discloses a temperature control system for the mixing of cold and hot water. A disadvantage of this and like systems is that it relies on a special non standard mixing device.

It is an object of the present invention to address or ameliorate some of the above disadvantages.

### Notes

The term “comprising” (and grammatical variations thereof) is used in this specification in the inclusive sense Of “having” or “including”, and not in the exclusive sense of “consisting only of”.

The above discussion of the prior art in the Background of the invention, is not an admission that any information discussed therein is citable prior art or part of the common general knowledge of persons skilled in the art in any country.

### SUMMARY OF INVENTION

Accordingly, in a first broad form of the invention, there is provided an electro-mechanical system for control of a standard, normally manually operable, cold and hot water mixing device; said system including a first actuator for control of a cold-hot water balance entering said mixing device and a second actuator for control of flow of mixed cold and hot water through said mixing device.

Preferably, said cold-hot water balance is controlled by a rotatable element rotating in clockwise and anticlockwise directions from a central position about an axis of said mixing device.

Preferably, said flow of mixed cold and hot water is controlled by a central shaft; said central shaft moveable transversely relative a central axis of said mixing device.

Preferably, said system further includes at least one sensor for monitoring characteristics of said mixed cold and hot water at an outlet of said mixing device.

Preferably, said system further includes any one of a flow sensor, a temperature sensor or a water pressure sensor located proximate each respective cold and hot water inlet of said mixing device.

Preferably, sensor data of flow, temperature or pressure from said flow, temperature or pressure sensors is monitored by a control module; said control module including a data storage element, data display element, input means and a central processor.

Preferably, wherein preferred characteristics of said mixed cold and hot water are recorded in said data storage element for subsequent use.

Preferably, said first and second actuators are responsive to said preferred characteristics of mixed cold and hot water, set as input data via input means of said control module; said control module transmitting controlling signals to said first and second actuators as functions of said sensor data and said preferred characteristics.

Preferably, said input means comprises a touch screen.

Preferably, wherein a cold-hot water mixture at said preferred characteristics is activated, by interaction of a user with a motion sensor.

Preferably, a cold-hot water mixture at a nominated combination of flow and temperature is activated by interaction of a user with one or more push-buttons.

Preferably, said first and second actuators are electric stepper or servo motors.

Preferably, said first and second actuators are shape memory muscle wires.

Preferably, a first said stepper or servo motor is mounted to a fixed non-rotating base plate; a spur gear on an output shaft of said first stepper or servo motor engaging with a gear quadrant of a rotation control plate; said rotation control plate rotating about said axis of said mixing device; said rotation control plate connected to said rotatable element of said mixing device to control said cold-hot water balance.

Preferably, a second said stepper or servo motor is mounted to said rotation control plate; a spur gear on an output shaft of said second stepper or servo motor engaging with a gear quadrant of a translation control plate; said translation control plate rotating about a pivot point offset from said axis of said mixing device; said translation control plate connected with said central shaft to control said flow of mixed cold and hot water.

Preferably, said system further includes a bypass valve downstream of said outlet; said bypass valve diverting water issuing from said outlet which is below a nominated temperature.

In another broad form of the invention, there is provided a method of electro-mechanical control of a standard cold-hot water mixing device; said cold-hot water mixing device normally manually operable; said method including the steps of:
(a) providing a first actuator for operating a cold-hot water balance element of said mixing device,
(b) providing a second actuator for operating a mixed cold-hot water flow control element of said mixing device,
(c) monitoring temperature and pressure or flow proximate at least an outlet of said mixing device,
(a) controlling said actuators according to said temperature and pressure and or flow data received by a control module so as to deliver a nominated flow of mixed cold and hot water from an outlet of said mixing device.

Preferably, said control module includes data storage elements, a central processing unit, a display means and data input means.

Preferably, algorithms store on said data storage elements operate on monitored said temperature and pressure or flow to activate said first and second actuators to provide nominated temperature and flow characteristics of mixed cold and hot water issuing from said device.

### BRIEF DESCRIPTION OF DRAWINGS

Embodiments of the present invention will now be described with reference to the accompanying drawings wherein:

FIG. 1 is a perspective view of a preferred mechanism for automated control of cold and hot water mixing and flow control according to the invention,

FIG. 2 is a first orthogonal view of the mechanism of FIG. 1 in a medium flow and medium temperature setting,

FIG. 3 is a second orthogonal view of the mechanism of FIG. 1 in maximum flow and maximum temperature setting,

FIG. 4 is a perspective view of a, typical cold and hot water mixer cartridge according to prior art.

### DESCRIPTION OF EMBODIMENTS

In each preferred embodiment of the invention, the cold and hot water mixing system makes use of existing plumbing elements for delivery of mixed cold and hot water to a single outlet. Thus the system and its components may be applied to conventional cold and hot water mixing devices commonly used in the art.

### First Preferred Embodiment

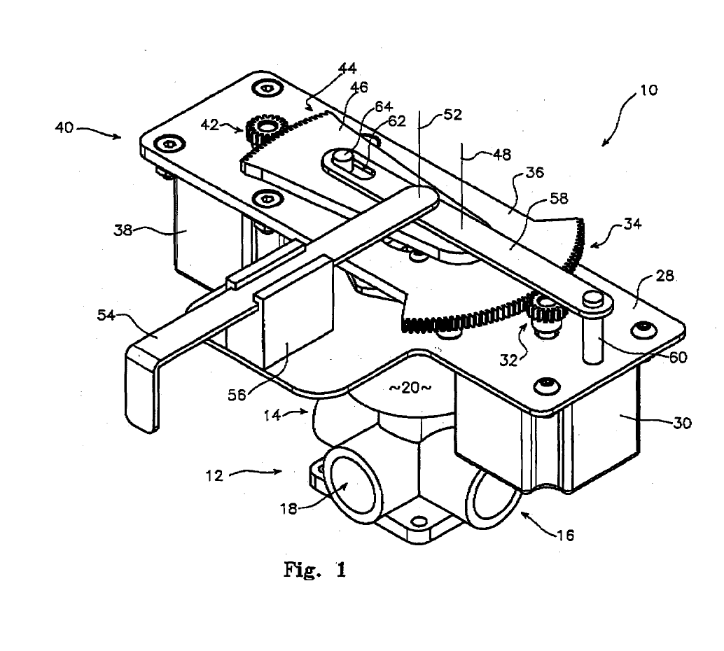

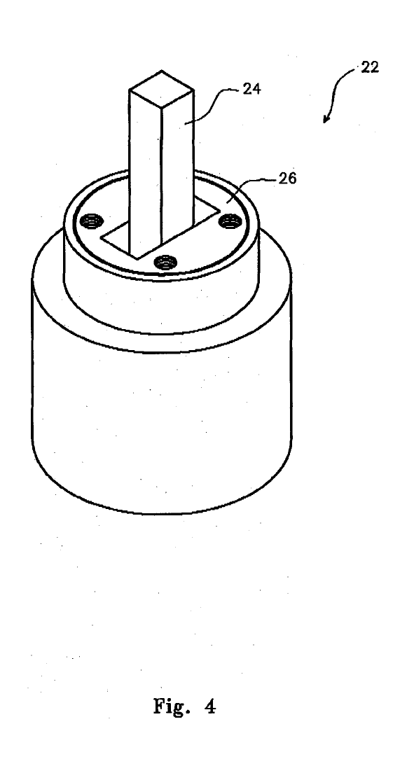

With reference to FIG. 1, the system of the invention in this embodiment includes a control mechanism 10 applied to a standard commercially available mixing device 12. Mixing device 12 comprises a cold water inlet 14, a hot water inlet 16 and a mixed cold-hot water outlet 18. Located in mixer cartridge housing 20, and interposed between the inlets 14 and 16 and the outlet 18, is a standard mixing and flow control cartridge 22 as shown in FIG. 4. The cartridge 22 is provided at its base with three orifices (not show) which interconnect with the water flow passages of the cold and hot water inlets 14 and 16 and the outlet 18 respectively, when the cartridge is located in the cartridge housing 20.

Flow control cartridge 22 typically includes cooperating passive and active ceramic disks, in which the active disk may be driven into rotation and translation by a single control element 24 projecting from the cartridge. Rotation of the control element 24 causes rotation of a rotary element 26 which engages with the active disc to rotate it. Lateral displacement of the control element 24 from its neutral or flow closing position, causes translation of the active disc, allowing flow of mixed water from the outlet 18.

Rotation controls the balance between the degrees of cold and hot water able to pass through the moveable disk, with translation controlling the rate of flow of the mixed water from the cartridge.

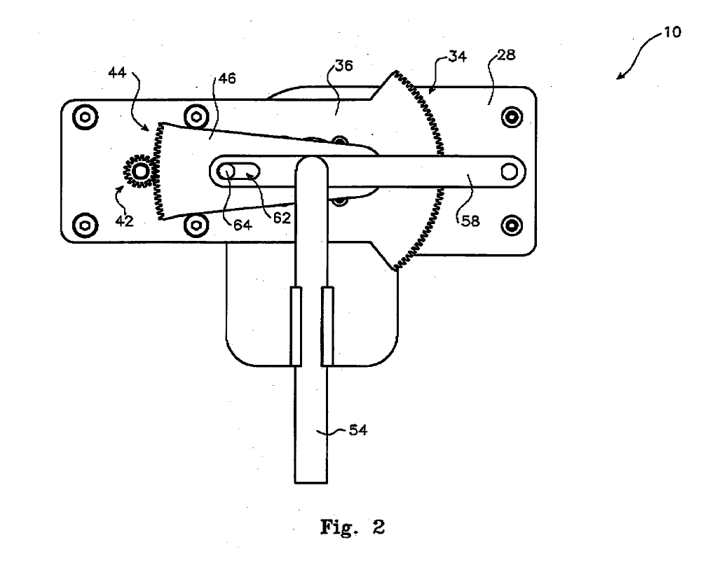

Turning again to FIGS. 1 to 3, in this preferred embodiment, the housing 20 for the standard mixer cartridge as described above, is rigidly mounted to a base plate 28. A first rotary actuator 30, provided with a spur gear 32, is mounted to the base plate 28. This first spur gear 32 of the first rotary actuator 30 meshes with a first gear quadrant 34 of a rotation control plate 36. This rotation control plate 36 rotates about the axis 52 of the mixer cartridge 22 when driven by the first spur gear 32. Rotation control plate 36 is connected to the rotary element 26 of the mixer cartridge. In the position of the rotation control plate 36 shown in FIGS. 1 and 2 with the spur gear at the mid-point of the gear quadrant 34, there is equal balance between the Cold and hot water passages through the cartridge 22 due to the rotation element 26 then being in its neutral, non-rotated position.

A second rotary actuator 38 is mounted to the rotation control plate 36 at its outer end 40, opposite to the first gear quadrant 34. A second spur gear 42 of the second rotary actuator 38, meshes with a second gear quadrant 44 of a translation control plate 46.

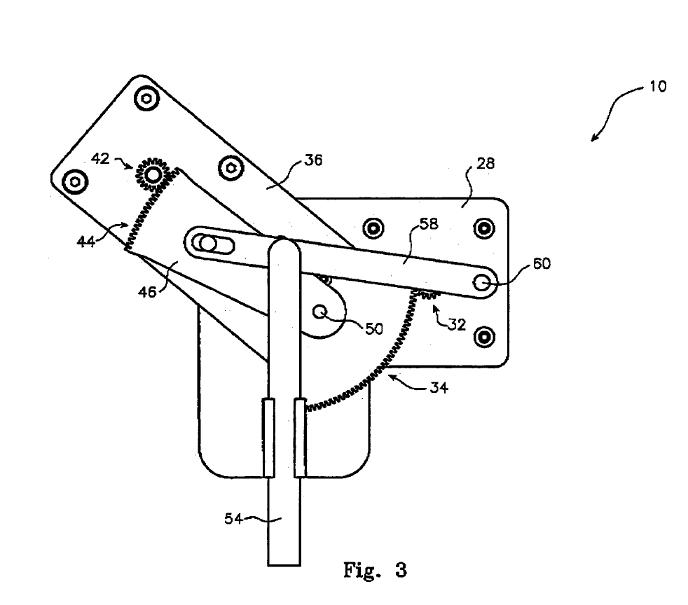

This translation control plate 46 pivots about the axis 48 of a pivot 50 (see FIG. 3) mounted on the rotation control plate 36, and is offset from the axis 52 of the mixer cartridge. The translation control plate 46 is provided with an aperture for nesting the end of the translation control element 24 of the mixer cartridge. This nesting aperture is offset somewhat from the axis of the mixer cartridge, the offset being such that the translation control element 24, is deflected to a medium flow position when the mechanism is in the disposition shown in FIGS. 1 and 2.

Alternatively, the translation control element 24 of a mixer cartridge which is normally pivoted about a transverse axis within the cartridge, may be replaced by a control post (not shown) rigidly attached to the underside of the translation control plate 46, to engage with the active ceramic disc of the cartridge.

A manual override mechanism may be provided. For example, in the system shown in FIGS. 1 to 3, the manual override comprises a manual control lever 54 sliding in a guide block 56 and a control bar 58. Control bar 58 pivots about pivot post 60 mounted to the base plate 28. It is provided at its opposite end with a slot 62 which engages with a control lug 64 mounted to the translation control plate 46. The control lever 54 and control bar 58 are pivotally interconnected. Manual operation is described below. This single lever system is particularly adapted to shut off cold and hot water flow.

It will be understood, that a manual override system could alternatively be provided to control both cold and hot water balance and flow control by the application of suitable levers to the two control plates of the invention. Preferably, in a domestic situation, the hot and cold water mixing device Of the invention may be installed behind an access panel adjacent to the location of use. In one preferred arrangement, the mixing device could be located behind the control module display.

When the first rotary actuator 30 is activated from the neutral position shown in FIGS. 1 and 2, the rotation control plate 36 is driven to rotate about the axis 52 of the mixer cartridge 24 and hence causes rotation of the rotary element 26 of the cartridge. As noted above, this rotary motion is transferred to the ceramic disc of the cartridge and, depending on the direction of rotation, will bias the ceramic disc to the entry into the cartridge of a greater proportion of either hot or cold water. In FIG. 3, the maximum clockwise rotation of the rotation control plate has set the mechanism to maximum flow of hot water.

When the second rotary actuator 38 is activated, it drives the translation control plate 46 to pivot about its pivot axis 48. The effect of this rotation is to laterally displace the aperture nesting the end of the control element 24 of the cartridge in the translation control plate 46 and hence displaces the control element 24 (or the control post attached to its underside) out of its neutral position. This translates the ceramic disc of the cartridge from the medium flow position shown in FIGS. 1 and 2, towards either a fully closed or fully open position. In FIG. 3, the translation control plate 46 has been rotated anticlockwise to a maximum flow position (in this case of hot water).

It will be understood that with electronically controlled rotary actuators such as stepper or servo motors for the first and second rotary actuators, fine tooth choice for the spur gears and gear quadrants, and with appropriate geometry of the rotation and translation plates, the mechanism can provide fine incremental control over both cold and hot water balance and flow.

The manual override mechanism described above, for use for example in the case of a power failure, allows the rotation control plate and the translation control plate to be driven into a desired relative position according to a desired cold and hot water balance and flow rate by means of sliding the annual control lever 54 to a suitable position.

Although in the mechanism described above, the preferred actuators 30 and 38 have been rotary, it will be understood that, both the rotation control plate 36 and the translation control plate 45 could be urged into rotation by suitable linear actuators. Linear actuators could include so called “muscle wire” actuators, formed of shape memory material and driven to expand or contract through the application of an electric current.

### Second Preferred Embodiment

In this second preferred embodiment, the standard mixing device to which the invention is applied is that of a conventional twin spindle tap arrangement at each end of a central breech or manifold. Respective cold and hot water inlets at the two taps are individually controlled by rotation of the tap spindles to allow mixed water to flow from an outlet spigot provided at the centre of the breech.

In this instance the preferred mechanism comprises an actuator for each of the tap spindles adapted to rotate the spindles between a tap valve closed position and a desired open position. Preferably, a mounting plate is attached to each tap body and a rotary actuator mounted to each mounting plate.

Each spindle is provided with a gear which engages with the respective spur gears of the rotary actuators.

As for the first embodiment above, the gear, rotary actuator and spur gear arrangement may be replaced by a linear actuator arrangement, in this case acting on lever arms attached to each of the tap spindles.

### Third Preferred Embodiment

In a further preferred embodiment of the invention, the electro-mechanical mixing device of the invention is incorporated in a portable cold and hot water mixing and delivery system. The portable system is particularly suited to the provision of shower facilities by careers and health workers to frail and disabled persons in their homes.

In this arrangement, the portable device comprises a control module, cold and hot water supply tanks, individual pumps for supply of cold and hot water, the mixing device and a shower head.

For use, the Cold and hot water tanks are filled on site and power connected. Where on-site hot water supply is adequate, the hot water tank may be supplied from the home system. Alternatively, the hot water tank may be provided with a heating element or a flow-through heating device may be interposed between the tank and the mixing device. A bypass system may be included so that mixed water which has not yet reached the predetermined temperature is returned to either of the two supply tanks.

### Control

In each of the above embodiments, the system of the invention includes at least a sensor for pressure and temperature proximate the outlet of the mixing device 12 to monitor temperature and flow of mixed water. Preferably, sensors for flow, pressure and temperature may be located proximate to each inlet 14 and 16 of the mixing device 12. When in use, sensor data of flow, temperature and pressure from these flow, temperature and pressure sensors is monitored by a control module, which includes a data storage element, data display element and a central processor.

The first and second actuators 30 and 38 of the control mechanism 10 of the invention are responsive to nominated flow rates and nominated temperatures of mixed cold and hot water set as input data via input means of the control module. The control module transmits controlling signals to the actuators as functions of the sensed data in real time to maintain the preferred characteristics of the cold-hot water mixture as nominated flow rate and nominated temperature.

Preferably, the display element of the control system is a water resistant touch screen mounted adjacent the outlet, such as a shower head, bath, hand basin or kitchen outlet serviced by the mixing device. Alternatively, the control panel could be provided with push-button controls, motion sensing controls or, in one preferred arrangement, with voice control.

By means of the memory facility in the control module, preferred settings for mixed cold and hot water delivery may be stored and recalled as required. Algorithms operating on the data provided by the sensors will then modulate the balance between the cold and hot water and the flow rate to deliver the required water characteristics.

The control module will allow the display and editing of sensor data and maintain and display usage over time for example.

### Water Saving Provisions

The system of the invention may further include electrically controlled by-pass valve/s prior to the point of use outlet to direct water to a storage vessel or vessels, or to other outlet points. An electric pump may then be employed to allow re-use of the diverted water. This diversion system may be provided to divert and store water coming from the mixing device which has not yet reached the desired delivery temperature.

### INDUSTRIAL APPLICABILITY AND SUMMARY

### Technical Postures of this Invention

This invention introduces electronics into what has been the manual operation of mixing hot and cold water. It incorporates manipulation of a mixing device/s by an electric motor/a or by muscle wire and electrical sensing of pressure, flow and temperature. It will also utilise electrically controlled valves to redirect water to a storage vessel/s or other point/s and an electric pump/s to assist with the re-use of water. These valves will also eliminate water waste which results from taps not being fully closed.

The invention will also utilise the redirection/use of waste water which enters the drainage system. Valve/s will be used to direct waste water to a storage vessel/s or another fitting/s or a discharge point.

The invention will permit selection and recording of a number of desired temperature and flow rates. It will also permit the visual display of data as well as editing and use of data. It will also allow manual operation, particularly in the event of power failure.

### Preferred or Optional Features

The introduction of electronics allows the following features to be incorporated:—
i) Electronic manipulation of the mixing unit/device to achieve desired flow and temperature.
ii) Ease of operation. Control of temperature and flow can be at the touch of a button, touching a ‘touch-screen’ or activation of a sensor such as a motion sensor.
iii) Selection/control of the commencement of the water flow from the outlet (particularly the flow of water at the desired temperature and rate of flow) so as to avoid hands or clothing being under running water when not desired.
iv) Maintenance of desired temperature and flow at the outlet, despite variations on the supply side of the system.
v) Assessment of pressure, flow, volume and temperature.
vi) Redirection of Water, in particular uncontaminated water.
vii) Re-use of uncontaminated water by re-introduction into the system or other means.
viii) Storage and heating of cooled water in the hot supply system before delivery to the mixing device to improve speed of delivery of the desired temperature and the efficient use of energy and water.
ix) Elimination of water waste which results from tap and mixer valves not being fully closed.
x) Redirection and use of waste water entering the drainage system.
xi) Restriction on maximum temperature at the water outlet.
xii) Cutoff of hot water supply to reduce the possibility of scalding.
xiii) Warning/alerting devices, such as visual and audible warnings, particularly to notify when water at the desired temperature and flow is ready to be delivered from the outlet or warning of the impending shut down of system.
xiv) Supplementary/separate systems to reduce the possibility of scalding.
xv) A means by which the Length of time the device has been operated can be monitored, displayed and controlled.
xvi) A means by which the device will automatically shut off water supply after a designated or selected period of time so as to restrict wastage of water.
xvii) The ability to serve more than one outlet from a mixing device.
xviii) The ability to control more than one mixing device or other devices. This includes controlling lights, equipment such as cooking appliances, water heating appliances, computers and the like.
xix) Analysis and logging Of data regarding fresh water usage and waste water usage or discharge over a given period of time.

The ability to control and monitor fittings serving a number of separate occupancies such as in hotel units or apartment buildings.
xxi) Visual and audio entertainment, including internet connectivity and the playing of music and video. Video display may be at the device or external to the device. The size of the display is unlimited and may be on the walls of a room or on or incorporated into a shower screen/s.
xxii) Video and audio messages.
   Methods for Putting Invention into Effect

Two options for putting the invention into effect are described as follows. Each option will generally, utilise the same arrangement of fittings but will introduce different components into the design.

### Method 1

Taps with electric motor (stepper motor/servo motor control etc) OR “muscle wire” linear, actuator—

### Design A

### The Pipe Arrangement

Preferably traditional plumbing fittings are utilised (metal or plastic). There is the traditional arrangement of hot and cold water supply pipes feeding into a breech or other fitting which is provided with taps to control and regulate the flow of hot and cold water to the outlet side of the fitting (as mixed water at a desired flow and temperature) and subsequently to an outlet (a shower rose fitting, basin spout etc.).

The taps may be exposed or partially exposed fittings or they may be totally concealed. They may be close to the outlet they are supplying or they may be remote from it.

### The Taps

The taps can be traditional threaded spindle taps with jumper valves which seal onto the seat of the breech fitting. Alternatively, ceramic disc taps can be used.

### The Motors

Electric stepper motors or electric servo motors or other type of electric motor are mounted adjacent to each of the taps. The motors are connected to the taps.

The motors are able to receive messages which cause them to rotate in either direction, thereby moving the taps.

### The Driving Mechanism

Each of the electric motors can be either directly connected to the tap spindle or alternatively, a system of gears can be utilised. Where threaded spindle tap is used it will need to be arranged in a way which will allow it to screw in and out without fouling the motor operation.

A stepper, servo or other type of electric motor is mounted adjacent to each of the taps on a fixed (non-rotating) base plate. The motor may be directly attached to the tap spindle or a gear can be attached to the motor and it, in turn, is meshed with another gear which is attached to the spindle of the tap. By controlling the movement of each of the motors, the water temperature and also the flow leaving each tap and subsequently the outlet point, will be regulated.

Alternatively, the method for obtaining the required movement described above can be provided by ‘muscle wire’ activators. To rotate each tap and hence provide variable temperature and flow of the corresponding mixed water, a muscle wire can be attached to the base plate at one end and the handle fixed to the spindle at the other. To provide movement in the opposite direction, a muscle wire can be provided in a similar format to that described above or a spring can be used.

When various levels of current are provided to the muscle wire/s the corresponding contraction and expansion of the muscle wire/s will provide the desired movement.

### The Handle

A handle is attached to each gear or directly on to the tap spindles. Its purpose is to permit manual operation of the tap, particularly, in the event of power failure. Where muscle wire is used a means for readily disconnecting one end will be employed.

### The Valve/s

Mixed water exiting the central pipe of the breech or similar fitting is able to be directed into the holding vessel or allowed to flow to the outlet of the system (shower rose, spout etc.) by the use of valves such as solenoid valves.

### The Control Mechanism for Basins/Tubs etc

Activation of the system, installed in a hand-basin eta can be by movement or similar sensors which respond to moving ones hands near the appropriate sensor to obtain the desired temperature or flow.

### The Holding Vessel

This is a tank for holding uncontaminated water. The inlet is connected to a valve and the outlet may be connected to a pump or another fitting.

### The Pump

An electric pump is connected to the outlet of the holding vessel. The pump can be connected, via a valve, to the mixed water outlet side of the taps. The pump can be utilised to convey water to another point other than back into the system. The pump may also deliver water to other plumbing fittings.

### The Sensors

Electronic devices are used to monitor flow, temperature and pressure of water. They will be connected to a control mechanism.

### The Control Mechanism

The operation of the motor/s and other electrical components together with the analysis of data is to be performed by an electronic device/s which incorporates a display screen. The system will preferably be operated by pressing a button/s or by a motion sensing device/s.

Upon activation, the electric motor/s will turn in the desired direction/s and thereby provide an ability to control both the temperature and the flow of water to the outlet. The motor/s will continue to move, as required, until the desired flow and temperature is achieved. The control mechanism will be able to limit the maximum temperature reaching the outlet of the system and also be able to shut off the flow of water to the outlet of the system by closing the tap/s or by a valve.

The electronics will also monitor water usage and analyse and provide data. This and other data can be outsourced via wired or wireless connection to an external computer or device.

Similarly the electronics will be able to access data from external sources such as the internet or computers. This will provide a data source for the electronic components to provide audio and video entertainment e.g. games, music, movies and video music, as well as messages. Audio and video entertainment will be also be sourced from other areas including the control mechanism's hardware.

### The Cover/Display Panel

The cover will house the control mechanism and preferably will be watertight. The display may be on the cover or may be affixed to the glazing of a shower screen or the walls of a roam. Where taps are exposed, the cover will preferably be used to cover them.

The cover can be designed to permit the holding of products such as hair shampoo, hair conditioner, razors, face washer/s etc. It may also incorporate a foot rest to assist in washing feet.

### Method 2

Mixing device with electric motor (stepper motor/servo motor/linear actuator control etc) OR “muscle wire” linear actuator

### Design b

### The Pipe Arrangement

Preferably traditional plumbing fittings are utilised (metal or plastic). There is the traditional arrangement of hot and cold water supply pipes feeding into a ‘manually’ controlled type of mixing device which controls and regulates the flow of hot and cold water to the outlet side of, the fitting (as mixed water at a desired flow and temperature) and subsequently to an outlet (a shower rose fitting, basin spout etc.).

### The Mixing Device

A traditional ceramic disc manual mixing device can be utilized.

The mixing device may be an exposed or partially exposed fitting or it may be totally concealed. It may be close to the outlet it is supplying or it may be remote from it.

### The Driving Mechanism

A stepper, servo or other type of electric motor is mounted adjacent to the mixing device on a fixed (non-rotating) base plate. A gear is attached to the motor and it, in turn, is meshed with another gear which is attached to the central rotating component of the mixing device cartridge in a way that will permit it to turn in either a clockwise or anti-clockwise direction without impeding the movement of the central shaft of the mixing cartridge. Alternatively, the gear which is attached to the motor may mesh with a gear or section of a gear which is attached to or is part of an arm which is attached to the central rotating component of the mixing device cartridge.

Adjusting the length of the arm will allow variations of the torque requirement of the motor. By controlling the movement and the direction of the motor, the water temperature leaving the nixing device will be regulated.

Another electric motor is attached either to the handle which in turn is attached to the central shaft of the mixing cartridge or, conversely, is attached to the plate. This motor may be a stepper, servo or linear activator or other type of electric motor. The motor drives a mechanist which is fixed in a manner which permits it to rotate around the base plate or it is fixed to the handle. Alternatively, the mechanism may be securely fixed to a secondary plate which freely rotates around the mixing device in alignment with the handle with the opposing end fixed to the handle.

This motor when activated will move the mixing device shaft back and forth in a rocking motion in the same way that a fixed handle of the manually operated mixing device operates. The motors are able to receive messages which cause them to move in either direction, thereby moving the gear or the mixer shaft as appropriate and thereby regulating both the flow and the temperature of the mixed water exiting the outlet of the mixing device.

Alternatively, the method for obtaining the required movement described above can be provided by ‘muscle wire’ activators. To rotate the central shaft and hence provide variable temperature of the corresponding mixed water, a muscle wire can be attached to the base plate at one end and an arm fixed to the central shaft at the other. To provide movement in the opposite direction, a muscle wire can be provided in a similar format to that described above or a spring can be used.

To provide variation in flow from the device a muscle wire/s can be attached to the handle. Again movement in the opposite direction can be obtained by muscle wire fixed to the base plate or may be provided by a spring.

When various levels of current are provided to the wirels the corresponding contraction and expansion of the wire/s will provide the desired movement.

### The Base Plate

This is a plate securely fixed to the mixing device. It has motor attached to it and may also have the mechanism attached to it. Alternatively it may have muscle wire attached, to it.

### The Mechanism

The mechanism can be the shaft from a linear actuator, a rack and pinion or an arm. The mechanism converts the circular rotation of the electric motor to a pushing and pulling action.

### The Handle

A handle is attached to the mixer shaft. Its purpose is to permit manual operation of the mixer in the event of power failure. Where muscle wire is used, a means for readily disconnecting one end will be employed. The handle may also support motor or provide a fixing point for the mechanism connected to motor. It may also be used as a fixing point for muscle wire.

### The Secondary Plate

This is a plate which freely rotates around the mixing device. It provides a mounting point for motor or conversely the mechanism. It rotates in alignment with the handle.

### The Valve/s

Mixed water exiting the central pipe is able to be directed into the holding vessel or allowed to flow to the outlet of the system (shower rose, spout etc.) by the use of valves such as solenoid valves.

### The Control Mechanism for Basins/Tubs etc

Activation of the system installed in a hand-basin etc can be by movement sensors or similar sensors which respond to moving ones hands near the appropriate sensor to obtain the desired temperature and/or flow.

### The Holding Vessel

This is a tank for holding uncontaminated grater. The inlet is connected to a valve and the outlet may be connected to a pump or another fitting.

### The Pump

An electric pump is connected to the outlet of the holding vessel. The pump can be connected, via a valve, to the mixed water outlet side of the mixing device. The pump can be utilised to convey water to another point other than back into the system. The pump may also deliver water to other plumbing fittings.

### The Sensors

Electronic devices are used to monitor flow, temperature and pressure of water. They will be connected to a control mechanism.

### The Control Mechanism

The operation of the motor/s and other electrical components together with the analysis of data is to be performed by an electronic device/s which incorporates a display screen. The system will preferably be operated by pressing a button/s or by a motion sensing device/s.

Upon activation, the electric motor/s will turn in the desired direction/s and thereby provide an ability to control both the temperature and the flow of water to the outlet. The motor/s will continue to move as required until the desired flow and temperature is achieved. The control mechanism will be able to limit the maximum temperature reaching the outlet of the system and also be able to shut off the flow of water to the outlet of the system by either moving the central shaft to the closed position or by closing a valve/s.

The electronics will also monitor water usage and analyse and provide data. This and other data can be outsourced via wired or wireless connection to an external computer or device. Similarly the electronics will be able to access data from external sources such as the Internet or computers. This will provide a data source for the electronic components to provide audio and video entertainment e.g. games, music, movies and video music, as well as messages. Audio and video entertainment will be also be sourced from other areas including the control mechanism's hardware.

### The Cover/Display Panel

The cover will house the control mechanism and preferably will be watertight. The display may be on the cover or may be affixed to the glazing of a shower screen or the walls of a room. Where the mixing device is exposed, the cover will preferably be used to cover them.

The cover can be designed to permit the holding of products such as hair shampoo, hair conditioner, razors, face washer/s etc. It may also incorporate a foot rest to assist in washing feet.

### Materials Used to Construct the Hot and Cold Water Mixer

The preferred materials will be brass, copper, stainless steel and plastic plumbing materials and fittings. All materials coming into contact with potable water will meet with applicable regulating legislation.

All sensing devices will preferably, be constructed of stainless steel.

The base plate, the mechanism, the handle and the secondary Plate can be brass, stainless steel or plastic.

Plastics can be used for components such as the gears and the cover/display panel.

1. An electro-mechanical system for control of a standard, normally manually operable, cold and hot water mixing device; said system including a first actuator for control of a cold-hot water balance entering said mixing device and a second actuator for control of flow of mixed cold and hot water through said mixing device.

2. The system of claim 1 wherein said cold-hot water balance is controlled by a rotatable element rotating in clockwise and anticlockwise directions from a central position about an axis of said mixing device.

3. The system of claim 1 wherein said flow of mixed cold and hot water is controlled by a central shaft; said central shaft moveable transversely relative a central axis of said mixing device.

4. The system of claim 3 wherein said system further includes at least one sensor for monitoring characteristics of said mixed cold and hot water at an outlet of said mixing device

5. The system of claim 3 wherein said system further includes any one of a flow sensor, a temperature sensor or a water pressure sensor located proximate each respective cold and hot water inlet of said mixing device.

6. The system of claim 4 wherein sensor data of flow, temperature or pressure from said flow, temperature or pressure sensors is monitored by a control module; said control module including a data storage element, data display element, input means and a central processor.

7. The system of claim 6 wherein preferred characteristics of said mixed cold and hot water are recorded in said data storage element for subsequent use.

8. The system of claim 1 wherein said first and second actuators are responsive to said preferred characteristics of mixed cold and hot water, set as input data via input means of said control module; said control module transmitting controlling signals to said first and second actuators as functions of said sensor data and said preferred characteristics.

9. The system of claim 8 wherein said input means comprises a touch screen.

10. The system of claim 1 wherein a cold-hot water mixture at said preferred characteristics is activated by (Currently amended) interaction of a user with a motion sensor.

11. The system of claim 1 wherein a cold-hot water mixture at said preferred characteristics is activated by interaction of a user with one or more push-buttons.

12. The system of claim 1 wherein said first and second actuators are electric stepper or servo motors.

13. The system of claim 1 wherein said first and second actuators are shape memory muscle wires.

14. The system of claim 12 wherein a first said stepper or servo motor is mounted to a fixed non-rotating base plate; a spur gear on an output shaft of said first stepper or servo motor engaging with a gear quadrant of a rotation control plate; said rotation control plate rotating about said axis of said mixing device; said rotation control plate connected to said rotatable element of said mixing device to control said cold-hot water balance.

15. The system of claim 14 wherein a second said stepper or servo motor is mounted to said rotation control plate; a spur gear on an output shaft of said second stepper or servo motor engaging with a gear quadrant of a translation control plate; said translation control plate rotating about a pivot point offset from said axis of said mixing device; said translation control plate connected with said central shaft to control said flow of mixed cold and hot water.

16. The system of claim 1 wherein said system further includes a bypass valve downstream of said outlet; said bypass valve diverting water issuing from said outlet which is below a nominated temperature.

17. A method of electro-mechanical control of a standard cold-hot water mixing device; said cold-hot water mixing device normally manually operable; said method including the steps of:
(a) providing a first actuator for operating a cold-hot water balance element of said mixing device,
(b) providing a second actuator for operating a mixed cold-hot water flow control element of said mixing device,
(c) monitoring temperature and pressure or flow proximate at least an outlet of said mixing device,
(d) controlling said actuators according to said temperature and pressure or flow data received by a control module so as to deliver a nominated flow of mixed cold and hot water from an outlet of said mixing device.

18. The method of claim 17 wherein said control module includes data storage elements, a central processing unit, a display means and data input means.

19. The method of claim 18 wherein algorithms store in said data storage elements operate on monitored said temperature and pressure or flow to activate said first and second actuators to provide nominated temperature and flow characteristics of mixed cold and hot water issuing from said device.
